(19) United States
(12) Patent Application Publication
(10) Pub. No.: US 2017/0344224 A1
(43) Pub. Date: Nov. 30, 2017

(54) SUGGESTING EMOJIS TO USERS FOR INSERTION INTO TEXT-BASED MESSAGES

(71) Applicant: Nuance Communications, Inc., Burlington, MA (US)

(72) Inventors: David Kay, Burlington, MA (US); Donni McCray, Burlington, MA (US); Fredrik Mannby, Burlington, MA (US); Ethan Bradford, Burlington, MA (US); Amanjot Singh, Burlington, MA (US); Gordon Waddell, Burlington, MA (US)

(21) Appl. No.: 15/167,150

(22) Filed: May 27, 2016

(51) Int. Cl. G06F 3/0481; G06F 3/0488; G06F 3/0484; G06F 17/27; G06F 3/0482

(52) U.S. Cl. CPC G06F 3/04817; G06F 17/2785; G06F 17/2705; G06F 3/0482; G06F 3/04842; G06F 3/0488

(57) ABSTRACT

Systems and methods are described herein for determining suggestions of emojis, and other pictorial or multimedia elements, to users based on the content (e.g., a derived intent, tone, sentiment, and so on) of their messages. In some embodiments, the systems and methods access a string of text input by a user of a messaging application of a computing device, assign a specific classification to the string of text, and identify one or more pictorial elements to present to the user for insertion into the string of text that are associated with the specific classification of the string of text.

### BACKGROUND

Mobile electronic devices (such as smart phones, personal digital assistants, computer tablets, smart watches, and so on) are ubiquitous. Mobile devices provide advanced computing capabilities and services to users, such as voice communications, text and other messaging communications, video and other multimedia communications, streaming services, and so on. Often, users, via their mobile devices, access such services as customers or subscribers of telecommunications carriers, which provide telecommunications networks within which the users make voice calls, send text messages, send and receive data, and otherwise communicate with one another.

Conventional text-based communication applications (e.g., text messaging, instant messaging, chats, email, and so on) often provide users with options for supplementing input text with pictorial elements, such as emojis and other ideograms, images, GIFs, animations, videos, and other multimedia content. Users may select and insert various elements into their message to provide an emotional or tonal context to their text-based content. For example, a user may write a message of:

“I guess I'll just see you later! [winking smiley emoji]”,

where the emoji of a face winking is inserted to convey a playful tone to a recipient of the message.

Given the popularity of this blended communication structure, there is a seemingly unlimited corpus of available elements from which a user may augment text-based messages. For example, virtual keyboards of mobile devices provide users with hundreds or thousands of emojis and other media that are available for selection when the users are inputting text via the keyboards. In addition, a user may supplement their social media content (e.g., tweets or posts) with GIFs and other they found when performing online searches.

### BRIEF DESCRIPTION OF THE DRAWINGS

Embodiments of the present technology will be described and explained through the use of the accompanying drawings.

FIG. 1 is a block diagram illustrating a suitable computing environment within which to suggest emojis (and other pictorial or multimedia elements) to users based on the content of messages.

FIG. 2 is a block diagram illustrating components of an emoji suggestion system.

FIG. 3 is a flow diagram illustrating a method for presenting suggested emojis to users of mobile devices.

FIG. 4 is a flow diagram illustrating a method for matching emojis to text-based content.

FIGS. 5A to 5D are display diagrams illustrating user interfaces for presenting suggested emojis to users.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Systems and methods are described herein for determining suggestions of emojis, and other pictorial or multimedia elements, to users based on the content of their messages (e.g., a derived intent, tone, sentiment, and so on).

In some embodiments, the systems and methods access a string of text input by a user of a messaging application of a mobile device, assign a specific classification to the string of text, and identify one or more pictorial elements to present to the user for insertion into the string of text that are associated with the specific classification of the string of text.

For example, the systems and methods may extract multiple, different n-gram features (e.g., unigrams or bigrams) from a text-based message, identify one or more emojis that are associated with features that match the extracted n-gram features of the text-based message, and present, to the user of the mobile device, the identified one or more emojis. The user may then select one of the presented emojis for insertion into the text-based message.

Determining and presenting suggested emojis and other multimedia elements to users inputting text-based messages may enable users to identify suitable or relevant emojis previously unknown to the users. Further, a virtual keyboard may utilize the systems and methods to surface uncommon or hard-to-find emojis contained in an associated emoji database when they are determined to be relevant or potentially of interest to the users. The systems and methods, therefore, facilitate the real-time identification and/or presentation of targeted, relevant emojis when users are creating or modifying text-based messages, among other benefits.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

### Examples of Suitable Computing Environments

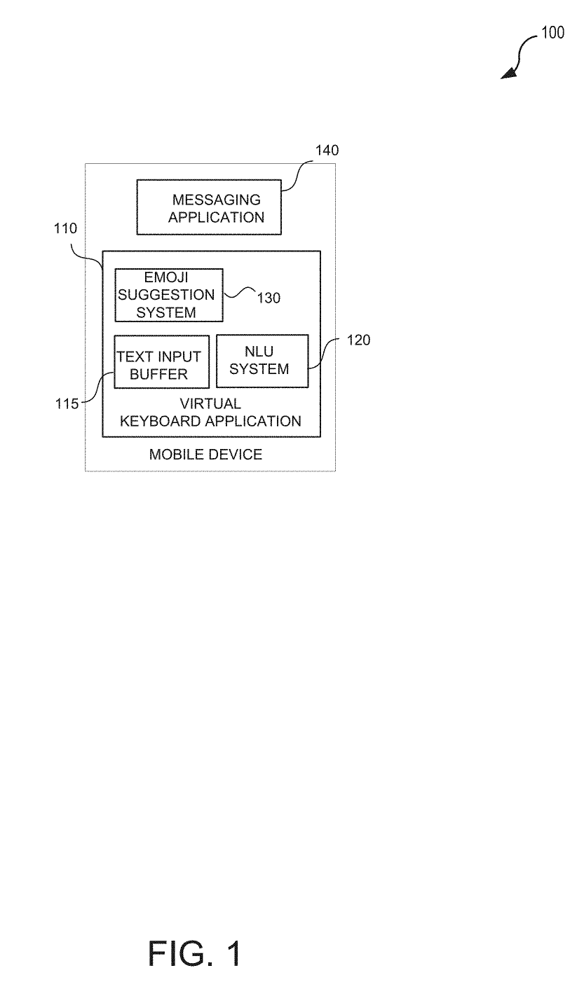

As described herein, in some embodiments, the systems and methods determine and/or present suggested emojis and other multimedia elements to users inputting text-based messages. FIG. 1 is a block diagram illustrating a suitable computing environment 100 within which to suggest emojis (and other pictorial or multimedia elements) to users based on the content of messages.

Unlike conventional systems, which provide pick lists and limited keyword matching of emojis for users, the systems and methods described herein facilitate the surfacing and/or suggestion of emojis based on a determined sentiment, tone or other inferred intent of a message. Thus, in some embodiments, the systems and methods suggest and/or present emojis and other pictorial elements for users to insert into a message that are based on a classification or sentiment of the complete message, or relevant portions thereof, and not based on single words within the message. As a result, users may discover previously unknown emojis and/or learn how certain emojis are used by others, among other benefits.

Referring to FIG. 1, the computing environment may include or be supported by a mobile device 100 or other computing device, such as a mobile or smart phone, tablet computer, laptop, mobile media device, mobile gaming device, vehicle-based computer, wearable computing device, and so on), to access various services (e.g., voice, message, and/or data services) supported by a telecommunications network (not shown) that is provided by a telecommunications (wireless) carrier and/or a wireless network (not shown).

The mobile device 100 includes a virtual keyboard application 110. The virtual keyboard application 110 may include an input layer or component configured to receive input (e.g., user-provided input) and produce a text string or text-based message within a text input buffer 115.

The virtual keyboard application 110 may interact with various applications supported by the mobile device 100, such as one or more messaging applications 140 (e.g., text messaging applications, email applications, chat applications, instant messaging applications, social network service applications, and so on), that facilitate the exchange of text-based communications between users, such as senders of messages and recipients of messages.

Because it is used with most applications 140 of the mobile device 100, the keyboard is a useful place to add functionality. Typically, the keyboard is a layer of software that is often or always accessible when using a computing or mobile device and its various applications. Therefore, adding other functionality within or associated with a keyboard would provide many benefits, such as easy or simple navigation between applications on a device, enhanced user interface capabilities, and other benefits. For example, the keyboard may act as an information exchange medium, enabling users to access data residing on their device or in locations to which their device communicates, exchange that information with applications or other programs running on the device, and parse the information in order to perform various actions based on the contents of the messages, as described herein.

The virtual keyboard application 110 may also include components/functionality of typical keyboard applications, such as components that may provide a text input functionality, a key tap functionality, a swipe, gesture, and/or contact movement functionality, or any other functionality that facilitates the reception of text-based input from a user. The components may cause the mobile device 100 to display a keyboard via a touch-screen, and receive input via a displayed keyboard presented via the touch-screen. The keyboard may be a virtual keyboard, such as any keyboard that is implemented on a touch-sensitive surface, a keyboard presented on a touch-sensitive display, a keyboard imprinted on a touch-sensitive surface, and so on. Example keyboards include a keyboard displayed on a monitor, a keyboard displayed on a touch-screen, a keyboard optically projected onto a flat or curved surface, and so on. In some cases, the keyboard may be “virtually” touched, such as a screen or projection that is controlled with some sort of pointer device or gesture recognizer.

In some embodiments, the virtual keyboard application 110 may perform recognition and/or disambiguation techniques to entered text when a user is inputting text, in order to assist users with entering text via small or complex displayed keys or keyboards.

In some cases, the systems and methods may be utilized by computing device having physical keyboards, such as laptops and other similar devices. In such cases, the systems may include components or elements that logically reside between an application or text field of the device, and a physical keyboard of the device.

In some embodiments, the virtual keyboard application 110, or computing device, may include a natural language understanding (NLU) system 120, which attempts to classify and identify or determine an intent or sentiment within contents of messages received by the messaging application 140 and accessed by the virtual keyboard application 110. The NLU system 120 may utilize various semantic or other natural language analyses, including previously performed analyses, when determining an intent or sentiment of the contents of a message. The NLU system 120 may classify messages with a variety of different classifications, in order to generate and present automated responses to messages. For example, the NLU system 120 may classify a message as being a question for the recipient, and generate a “yes” automated response and a “no” automated response.

The NLU system 120 may utilize a variety of techniques when classifying or otherwise determining intent or sentiment for contents of messages and other strings of text. In some cases, the NLU system 120 may parse the messages and identify keywords associated with classifications. For example, the NLU system 120 may identify certain features within messages, and classify the messages, along with associated confidence scores, based on the features of the messages.

In some cases, the NLU system 120 may analyze the syntax or structure of the message, as well as other messages (e.g., previous messages) within a thread of messages, when determining intent, sentiment, otherwise classifying messages (or portions thereof). For example, the NLU system 120 may analyze a message string of: Sender—“hey, how are you feeling?”; Recipient—“not great”, and determine a classification of the Recipient's message of “sick” based on the feature “not great” and the context provided by the Sender's message.

The NLU system 120 may classify messages based on a continued machine learning of a user's (and associated or un-associated users) writing patterns and language tendencies. For example, the NLU system 120 may initially or at a first time classify a message of “get out of here, please” as a certain emotion for the user, and then, by learning a user's language patterns, determine the user is merely typing an often used expression.

As described herein, the virtual keyboard application 110 also includes an emoji suggestion system 130, which determines or identifies emojis to present to a user based on the classifications or determined sentiments within messages. Further details regarding the emoji suggestion system 130 are described herein.

Although shown in FIG. 1 as being integrated with the virtual keyboard application 110, the emoji suggestion system 130 may be implemented as part of the messaging application 140, as a stand-alone application within the operating system of the mobile device 100, and do on. Further, other computing devices, such as devices with physical keyboards, may include and/or utilize the emoji suggestion system 130, such as with their messaging applications, email applications, browsers, and so on.

The emoji suggestion system 130, in some embodiments, may include various components of the NLU system 120, and may be integrated with the NLU system 120 as one combined system that parses messages to extract features from the messages, and suggests emojis and other pictorial elements for insertion into the messages based on a classification of the extracted features.

FIG. 1 and the discussion herein provide a brief, general description of a suitable computing environment in which the systems and methods can be supported and implemented. Although not required, aspects of the emoji suggestion system 130 (and, NLU system 120) are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

In some embodiments, the mobile device 100 may include network communication components that enable the mobile device 100 to communicate with remote servers or other portable electronic devices by transmitting and receiving wireless signals using a licensed, semi-licensed, or unlicensed spectrum over communications network, such as network. In some cases, the communication network may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. The communications network may also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), or other communications network.

Those skilled in the art will appreciate that various other components may be included in the mobile device 100 to enable network communication. For example, the mobile device 100 may be configured to communicate over a GSM or newer mobile telecommunications network. As a result, the mobile device 100 may include a Subscriber Identity Module (SIM) card that stores an International Mobile Subscriber Identity (IMSI) number that is used to identify the mobile device 100 on the GSM mobile or other communications networks, for example, those employing 3G and/or 4G wireless protocols. If the mobile device 100 is configured to communicate over another communications network, the mobile device 100 may include other components that enable it to be identified on the other communications networks.

In some embodiments, the mobile device 100 may include components that enable them to connect to a communications network using Generic Access Network (GAN), Unlicensed Mobile Access (UMA), or LTE-U standards and protocols. For example, the mobile device 100 may include components that support Internet Protocol (IP)-based communication over a Wireless Local Area Network (WLAN) and components that enable communication with the telecommunications network over the IP-based WLAN. Further, while not shown, the mobile device 100 may include capabilities for permitting communications with satellites. The mobile device 100 may include one or more mobile applications that transfer data or check-in with remote servers and other networked components and devices.

Further details regarding the operation and implementation of the emoji suggestion system 130 will now be described.

Examples of Suggesting Emojis for Insertion into Text-Based Messages

The emoji suggestion system 130, as described herein, is configured to determine a sentiment associated with a message input by a user, and present suggested emojis and other pictorial elements (e.g., emoji sequences, images, GIFs, videos, and so on) for insertion into the message that are based on the determined sentiment of the message.

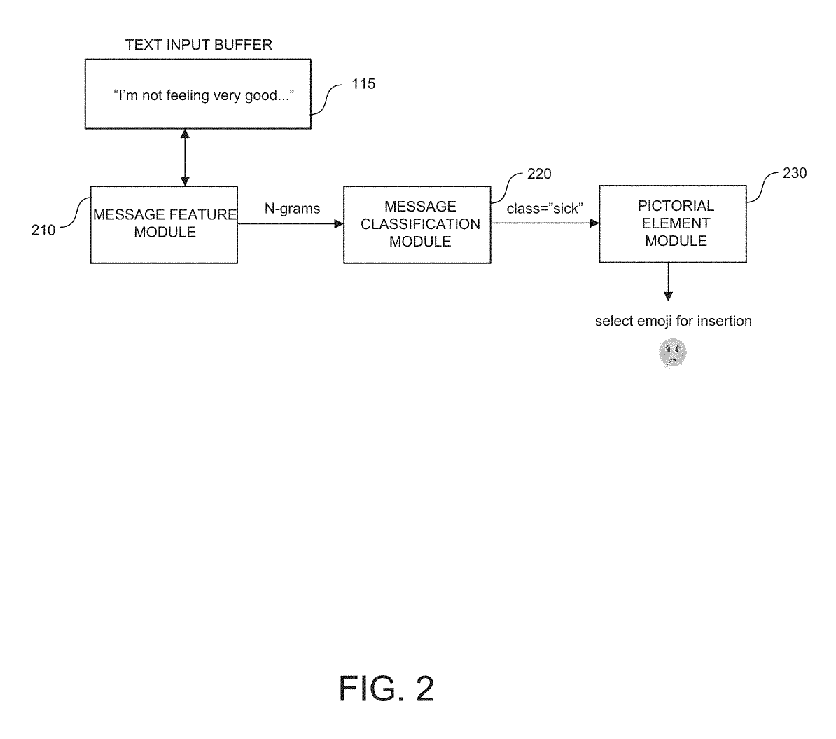

FIG. 2 is a block diagram illustrating components of emoji suggestion system 130. The emoji suggestion system 130 may include functional modules that are implemented with a combination of software (e.g., executable instructions, or computer code) and hardware (e.g., at least a memory and processor). Accordingly, as used herein, in some examples, a module is a processor-implemented module and represents a computing device having a processor that is at least temporarily configured and/or programmed by executable instructions stored in memory to perform one or more of the particular functions that are described herein. For example, the emoji suggestion system 130 may include a message feature module 210, a message classification module 220, and a pictorial element module 230.

In some embodiments, the message feature module 210 is configured and/or programmed to identify one or more features of a text-based message. The message feature module 210 may extract some or all n-grams of the message, such as unigrams, bigrams, and so on, in order to assign one or more classifications to the message.

For example, a message of “That does not sound good” may include the following bigram features:

“that does”,

“does not”,

“not sound”,

“sound good”,

as well as other n-grams, such as “not sound good.”

In some cases, the message feature module 210 may extract a certain number of tokens (e.g., single words) within the message for use in identifying features. Given a long or dense message of many words, the message feature module 210 may identify an insertion point within the message, and use the previous ten or fifteen tokens from the insertion point as the range of words from which to extract features.

For example, given a message of:

“I don't know, I'm just not feeling it, you know?|Anyways, let me know what you doing later? I'll be online at 8”,

the message feature module 210 may determine the user has selected an insertion point (shown as a “|”) right after the word “know. Based on the location of the insertion point, where the user is likely to insert an emoji, the message feature module 210 may only utilize the tokens previous to the insertion point (e.g., “I don't know, I'm just not feeling it, you know”) when extracting features from the message for classification.

In some embodiments, the message classification module 220 is configured and/or programmed to classify the message based on the identified features. For example, the classification module 220 may utilize the NLU system 120 to assign one or more classifications, and associated relevancy or confidence scores, to the features of the message. The assigned classifications may be general, or may be specific to various sentiments implied by the messages. Example sentiment classifications may include “sad,” “happy,” “angry,” “disappointed,” “mad,” “hopeful,” “worried,” “loving,” “flirtatious,” “shy,” and many others.

In some cases, the classifications may include or be formed based on clusters of messages or terms, with no explicit label assigned to classes. Thus, a class assigned to messages may be a cluster, such as a machine-learned cluster of messages with similar sets of features, optionally labeled or tagged.

Following the example for the message “That does not sound good,” the message classification module 220 may assign classifications of “negative,” “worried,” and “wary,” to the message.

In some embodiments, the pictorial element module 230 is configured and/or programmed to select one or more pictorial elements to present to the user for insertion into the message that are associated with the classification of the message. For example, the pictorial element module 230 may match the assigned classifications to classifications associated with emojis (via tags or other metadata associated with the emoji images) or other pictorial elements available for insertion into the message, and present the matched emojis to the user.

The pictorial element module 230 may select a variety of different types of pictorial elements for insertion into a text-based message. Examples include:

emojis and other ideograms, such as [sad face emoji] or [palm tree emoji];

emoji sequences (e.g., sequences of two or more emojis that combine to form a single sentiment), such as: [weight lifter emoji], [salad emoji], [flexing bicep emoji];

GIFs and other video sequences; and so on. Of course, other ideograms or pictorial elements not disclosed herein may be utilized by the module 230.

The pictorial element module 230 may surface, present, display (or, cause to be displayed) the selected pictorial elements in a variety of ways. For example, the module 230 may present a single, selected emoji, such as via a user-selectable button displayed by a virtual keyboard.

In some cases, the pictorial element module 230 may generate a list or menu of emojis that are associated with the classification (or, classifications) of the message, and present the list of emojis to the user as suggested emojis. The list may be presented along with other input suggestions (e.g., along with word or text predictions), and/or may replace a top or initial menu of emojis available for insertion into the message.

In some embodiments, the emoji suggestion system 130 may generate a database of entries that relate emojis to assigned classifications in a variety of ways. The system 130 may access and analyze a known or available body of text (e.g., a body of social media messages, such as tweets) to identify how other users pair or otherwise use words and phrases of messages with emojis. For example, when generating the database, the system 130 may create entries that relate specific emojis with identifiers for the emojis and metadata or tags derived from the various message corpuses.

The system 130 may generate the database of message-emoji pairings and associations as follows: First, the system 130 scans or reviews a corpus of language-specific short messages (e.g., tweets) for messages containing emojis or other elements. In some cases, the system 130 may scan for messages having single emojis, multiple emojis, and so on.

The system 130 identifies the target emoji, removes the target emoji from the message, and generates features from the text-based contents of the message. For example, as discussed with respect to the NLU system 120, the system 130 generates potential features for each unigram and bigram with the message, as well as bigrams by “hallucinating” or otherwise mimicking a start token at the beginning of the message and a stop token at the end of the message.

The system 130 may also generate special features from the message, such as features associated with the presence of unknown tokens, profanity, average word length, message length, sentiment classifications, and so on. In some cases, the system 130 may generate features based also on trigrams and order-agnostic co-occurrence bigrams within specified token windows (e.g., up to ten tokens).

Next, the system 130 canonicalizes features using XT9 capitalization or other similar methods, as well as converts of out-of-vocabulary words (e.g., unknown) to an “unknown” token, and numerical expressions to a “number” token. In some cases, the system 130 may canonicalize misspelled words, such as words with repeated letters, such as “musicccc”. The system 130 may also canonicalize features by treating words that have similar functions or meanings (e.g., “hello” and “greetings”, or “http://bit.ly/12345” and http://bit.ly/skajdf;lkj) as identical, and perform other transformations on the text to improve the relevance of the pairings.

Then, in some cases, the system 130 filters the features, such that the used features are features that (1) occur more than N times (e.g., 20) in the corpus, and (2) occur in less than P percent (e.g., less than 10%) of the messages. The filtering may remove very common or common features (e.g., common words or phrases like “of the”) while maintaining meaningful, frequently used features for analysis and classification.

The system 130 may determine the relative weights or rankings to apply to features, such as by performing a tf-idf (term frequency—inverse document frequency) transformation. The system 130 computes an L1-penalized Logistic Regression for samples and training labels (e.g., expected emoji), and, in some cases, alters the weights of the training examples to enable a “balanced” model of all target labels/classes/emojis. In other cases, the system 130 removes a generated a-priori bias learned for each label/class/emoji, to reduce the likelihood of predicting commonly used emoji.

The system 130 then utilizes the resulting model that correlates features and emoji, or features and classifications, when matching features of messages to identify relevant or suggested emojis. For example, the system 130, via the pictorial element module 230, may perform a dot product of the features and the model to determine matching emojis or classifications, with the one or more top-scoring emojis being selected for presentation to the user. Classifications may be equivalent to emojis, or may be more abstract, with a separate weighted mapping between classifications and emojis.

Thus, as described herein, the emoji suggestion system 130 utilizes previous uses of emojis within messages to classify features of a current message and suggest emojis to be inserted into the message that are associated with a sentiment (learned or classified) determined from the features of the message. The system 130 may perform various processes or operations when determining and/or presenting emoji suggestions to users.

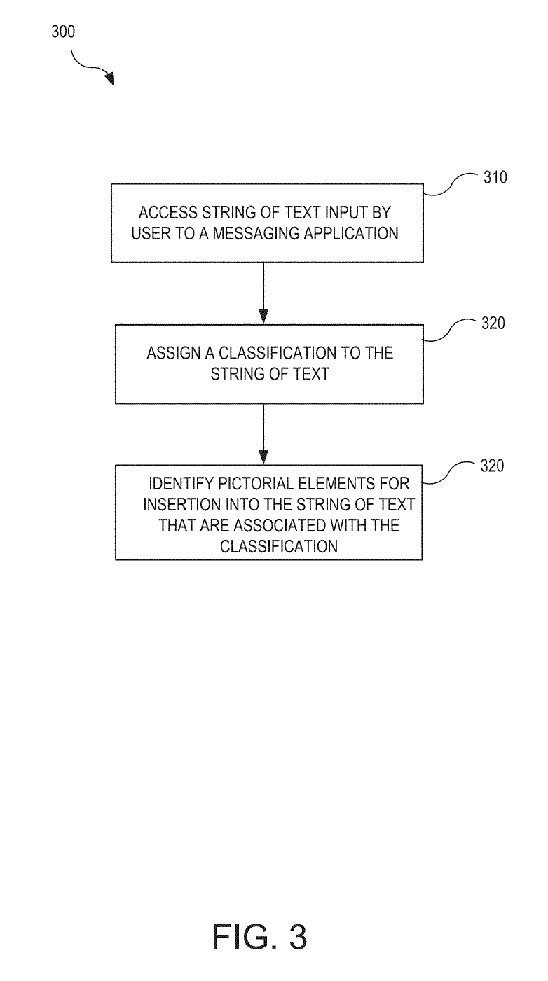

FIG. 3 is a flow diagram illustrating a method 300 for presenting suggested emojis to users of mobile devices. The method 300 may be performed by the emoji suggestion system 130 and, accordingly, is described herein merely by way of reference thereto. It will be appreciated that the method 300 may be performed on any suitable hardware.

In operation 310, the emoji suggestion system 130 accesses a string of text input by a user of a messaging application of a mobile device. For example, the message feature module 210 may extract some or all n-grams of the message, such as unigrams, bigrams, and so on, in order to assign one or more classifications to the message.

In operation 320, the emoji suggestion system 130 assigns a specific classification to the string of text. For example, the classification module 220 may utilize the NLU system 120 to assign one or more classifications, and associated relevancy or confidence scores, to the features of the message. The assigned classification may be a sentiment classification, a tone classification, and so on.

In operation 330, the emoji suggestion system 130 identifies one or more pictorial elements to present to the user for insertion into the string of text that are associated with the specific classification of the string of text. For example, the pictorial element module 230 may match the assigned classifications to classifications associated with emojis and other elements available for insertion into the message, such as one or more emojis within a database of emojis available to be presented to the user for selection via a virtual keyboard of the mobile device 100, and present the matched emojis to the user.

As described herein, the pictorial element module 230 may present, via a virtual keyboard of the mobile device, the identified one or more pictorial elements to the user of the mobile device 100, such as multiple different emojis that are dynamically associated with the assigned specific classification of the string of text, multiple different emoji sequences that are dynamically associated with the assigned specific classification of the string of text, one or more ideograms that are dynamically associated with the assigned specific classification of the string of text, one or more GIFs that are dynamically associated with the assigned specific classification (or, weighted, multiple classifications) for the string of text, and so on.

In some cases, a user may modify or add to a message after the emoji suggestion system 130 has presented one or more suggested emojis for insertion into the message. In such cases, the system 130 may determine that the message has been modified by the user, adjust the assigned classification based on the modification to the message, and identify one or more pictorial elements to present to the user for insertion into the string of text that are associated with the adjusted classification of the modified string of text.

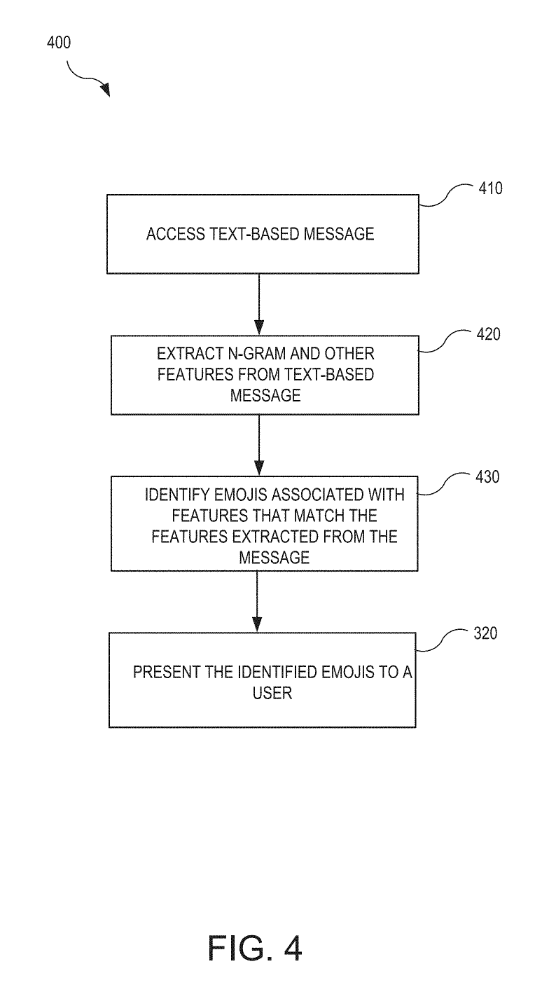

As described herein, the emoji suggestion system 130 may extract various features of message when determining what emoji to suggest for insertion into the messages. FIG. 4 is a flow diagram illustrating a method 400 for matching emojis to text-based content. The method 400 may be performed by the emoji suggestion system 130 and, accordingly, is described herein merely by way of reference thereto. It will be appreciated that the method 400 may be performed on any suitable hardware.

In operation 410, the emoji suggestion system 130 accesses a text-based message input by a user of a mobile device into a messaging application of the mobile device using a virtual keyboard provided by the mobile device, and in operation 420, extracts multiple, different n-gram features from the text-based message. For example, the message feature module 210 may extract unigrams and bigrams from the text-based message.

In operation 420, the emoji suggestion system 130 identifies one or more emojis that are associated with features that match the extracted n-gram features of the text-based message. For example, the system 130 may perform some or all of the following operations, as described herein, when matching features or messages to features associated with emojis available for suggestion:

Building a classification model that relates emojis to n-gram features of text, wherein the classification model is built by analyzing a corpus of previously entered messages that include text and at least one emoji, extracting n-gram features from the previously entered messages, canonicalizing the extracted n-gram features, filtering the canonicalized n-gram features to remove common canonicalized n-gram features, pairing the filtered n-gram features and their respective messages, and assigning weights to the emoji and n-gram pairs.

Comparing the n-gram features identified in the text-based message to the paired n-gram features, and

Selecting one or more emojis based on the comparison.

In operation 430, the emoji suggestion system 130 presents, to the user of the mobile device, the identified one or more emojis. For example, the pictorial element module 230 may surface, present, display (or, cause to be displayed) the selected pictorial elements in a variety of ways. For example, the module 230 may present a single, selected emoji, such as via a user-selectable button displayed by a virtual keyboard.

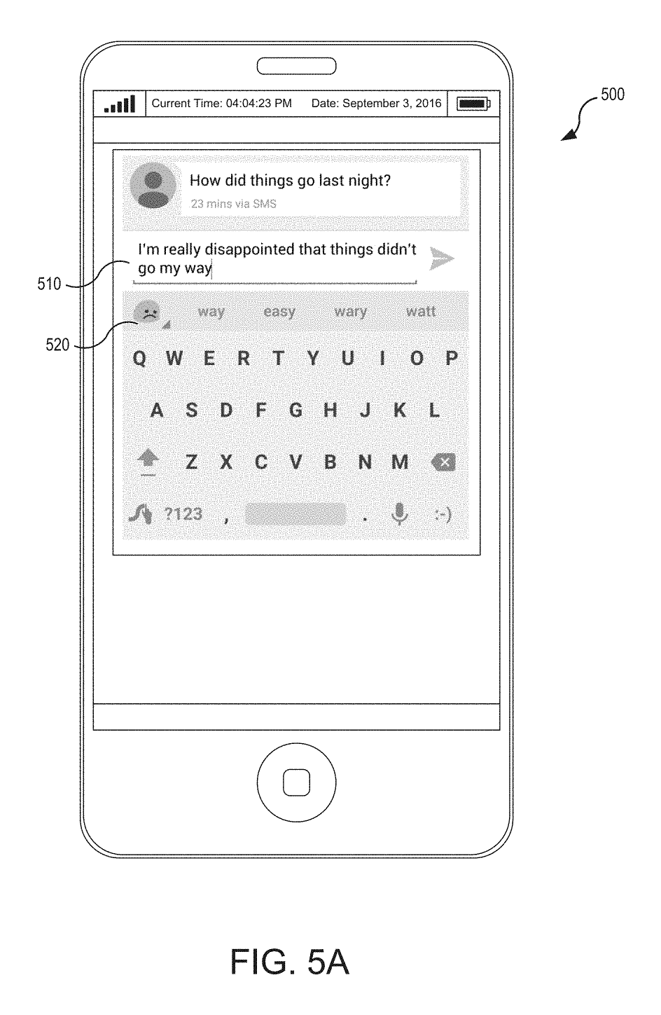

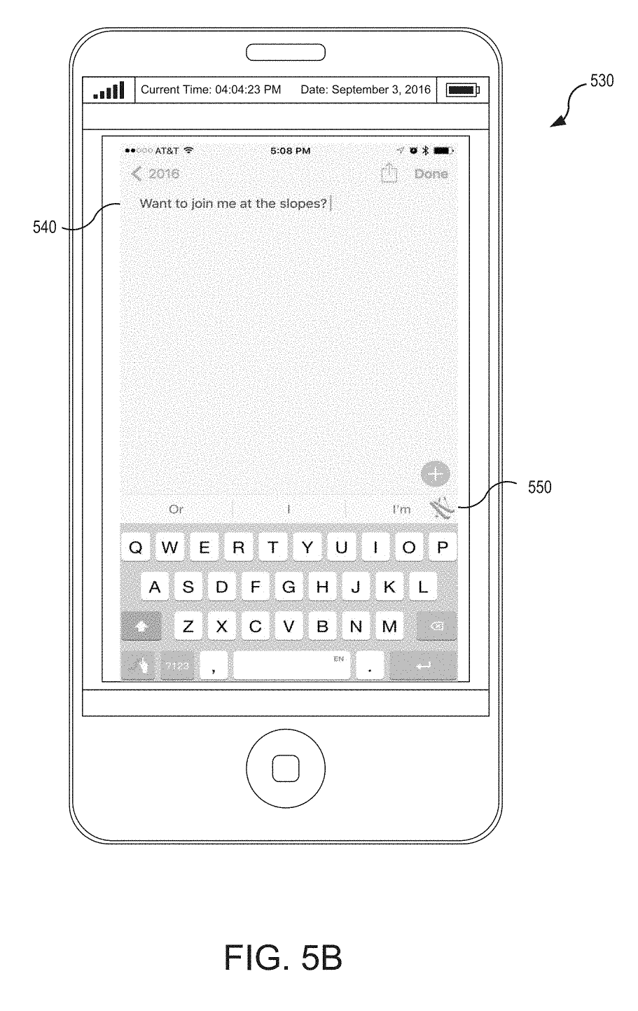

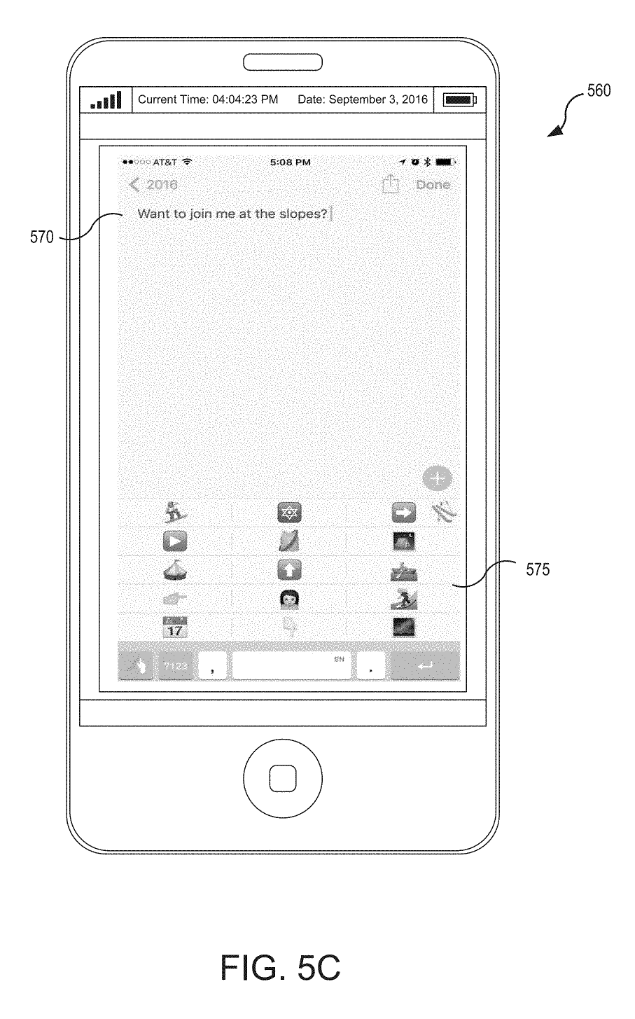

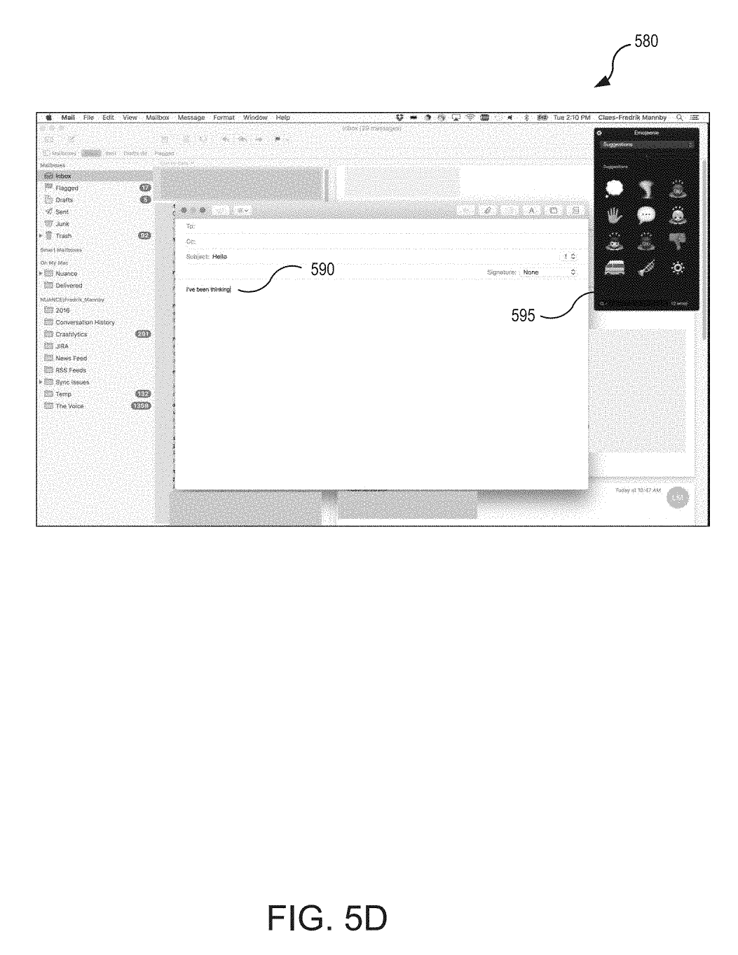

FIGS. 5A to 5D are display diagrams illustrating user interfaces for presenting suggested emojis to users. FIG. 5A depicts a user interface 500 of a messaging application that presents an emoji to a user of a mobile device by displaying, by the virtual keyboard, a user-selectable button 520 associated with a suggested emoji that, when selected by the user of the mobile device, cause the virtual keyboard to insert the emoji into a text-based message 510 or other message field (e.g., non-text based fields within messages).

FIG. 5B depicts a user interface 530 of a messaging application that presents an emoji to a user of a mobile device by displaying, by the virtual keyboard, a user-selectable emoji option 550 (along with other suggested text inputs) that, when selected by the user of the mobile device, cause the virtual keyboard to insert the emoji into a text-based message 540.

FIG. 5C depicts a user interface 560 of a messaging application that presents a menu 575 of suggested emojis that, when one of the menu options is selected by the user of the mobile device, cause the virtual keyboard to insert the associated emoji into a text-based message 570.

FIG. 5D depicts a user interface 580 of an email application that presents a pop-up menu 595 of suggested emojis that, when one of the menu options is selected by the user of a laptop or other computing device, cause the email application to insert the associated emoji into an email message 590.

Of course, the system 130 may perform other types of suggested emoji presentations.

Thus, in some embodiments, the systems and methods described herein enable messaging applications and other applications that receive text from users to present emojis and other pictorial elements for insertion into the message by the users that are based on the sentiment, aim, tone, or other contextual determinations about the message, among other benefits.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. §112(f) will begin with the words “means for”, but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

What is claimed is:

1. A method, comprising:
accessing a text-based message input by a user of a mobile device into a messaging application of the mobile device,
wherein the user is using a virtual keyboard provided by the mobile device;
extracting multiple, different n-gram features from the text-based message;
automatically identifying one or more emojis that are associated with features that match the extracted n-gram features of the text-based message; and
presenting, to the user of the mobile device, the identified one or more emojis,
wherein the one or more identified emojis are selectable by the user for insertion into the text-based message.

2. The method of claim 1, wherein identifying one or more emojis that are associated with features that match the extracted n-gram features of the text-based message includes:
building a classification model that relates emojis to n-gram features of text, wherein the classification model is built by:
analyzing a corpus of previously entered messages that include text and at least one emoji;
extracting n-gram features from the previously entered messages;
canonicalizing the extracted n-gram features;
filtering the canonicalized n-gram features to remove common canonicalized n-gram features;
pairing the filtered n-gram features and their respective messages; and
assigning weights to the emoji and n-gram pairs;
comparing the n-gram features identified in the text-based message to the paired n-gram features; and
selecting one or more emojis based on the comparison.

3. The method of claim 1, further comprising:
determining the user has input additional text to the text-based message;
extracting multiple, different n-gram features from the additional text input to the text-based message;
identifying one or more additional emojis that are associated with features that match the extracted n-gram features of the additional text input to the text-based message; and
presenting, to the user of the mobile device, the identified one or more additional emojis.

4. The method of claim 1, wherein presenting the identified one or more emojis to the user of the mobile device includes displaying, by the virtual keyboard, user-selectable buttons associated with the identified one or more emojis that, when selected by the user of the mobile device, cause the virtual keyboard to insert an emoji into the text-based message.

5. The method of claim 1, wherein presenting the identified one or more emojis to the user of the mobile device includes displaying, proximate to a display window of the messaging application, one or more user-selectable buttons associated with the identified one or more emojis that, when selected by the user of the mobile device, cause a selected emoji to be inserted into the text-based message.

6. The method of claim 1, wherein extracting multiple, different n-gram features from the text-based message includes extracting unigrams and bigrams from the text-based message.

7. The method of claim 1, further comprising:
assigning a sentiment based classification as a feature to the text-based message;
wherein identifying one or more emojis that are associated with features that match the extracted n-gram features of the text-based message includes identifying one or more emojis that are associated with the sentiment based classification of the text-based message.

8. The method of claim 1, wherein identifying one or more emojis that are associated with features that match the extracted n-gram features of the text-based message includes identifying one or emoji sequences that are associated with the features that match the extracted n-gram features of the text-based message.

9. The method of claim 1, wherein identifying one or more emojis that are associated with features that match the extracted n-gram features of the text-based message includes identifying one or more emojis from a corpus of emojis stored in an emoji database and accessible by the virtual keyboard.

10. A non-transitory computer-readable storage medium whose contents, when executed by an application of a computing device, causes the application to perform a method for determining a pictorial element to suggest to a user to add to a message being composed via a messaging application, the method comprising:
accessing a string of text input by a user of the messaging application of the computing device;
assigning a specific classification to the string of text; and
identifying one or more pictorial elements to present to the user for insertion into the string of text
wherein the one or more pictorial elements are associated with the specific classification of the string of text.

11. The computer-readable medium of claim 10, further comprising:
presenting, via a virtual keyboard of the computing device, the identified one or more pictorial elements to the user of the computing device.

12. The computer-readable medium of claim 10, wherein identifying one or more pictorial elements to present to the user includes identifying one or more emojis within a database of emojis available to be presented to the user for selection via a virtual keyboard of the computing device.

13. The computer-readable medium of claim 10, wherein the identified one or more pictorial elements include multiple different emojis that are dynamically associated with the assigned specific classification of the string of text.

14. The computer-readable medium of claim 10, wherein the identified one or more pictorial elements include multiple different emoji sequences that are dynamically associated with the assigned specific classification of the string of text.

15. The computer-readable medium of claim 10, wherein the identified one or more pictorial elements include one or more ideograms that are dynamically associated with the assigned specific classification of the string of text.

16. The computer-readable medium of claim 10, wherein the identified one or more pictorial elements include one or more GIFs that are dynamically associated with the assigned specific classification of the string of text.

17. The computer-readable medium of claim 10, wherein assigning a specific classification to the string of text includes assigning a specific sentiment classification to the string of text.

18. The computer-readable medium of claim 10, further comprising:
determining that the string of text has been modified by the user;
adjusting the assigned classification based on the modified string of text; and
identifying one or more pictorial elements to present to the user for insertion into the string of text that are associated with the adjusted classification of the modified string of text.

19. A system, comprising:
a message feature module that identifies one or more features of a text-based message;
a classification module that classifies the message based on the identified features; and
a pictorial element module that selects one or more pictorial elements to present to the user for insertion into the message that are associated with the classification of the message.

20. The system of claim 19, wherein the selected pictorial elements include emojis and emoji sequences.
